(19) United States
(12) Patent Application Publication
(10) Pub. No.: US 2015/0177590 A1
(43) Pub. Date: Jun. 25, 2015

(54) High Molecular Weight Steric Barrier for Electrophoretic Particles

(71) Applicant: E Ink California, LLC, Fremont, CA (US)

(72) Inventor: Peter B. Laxton, Marshfield, MA (US)

(21) Appl. No.: 14/638,924

(22) Filed: Mar. 4, 2015

Related U.S. Application Data
(63) Continuation-in-part of application No. 13/338,050, filed on Dec. 27, 2011, now abandoned.

(51) Int. Cl. G02F 1/167; G02F 1/1333

(52) U.S. Cl. CPC G02F 1/167; G02F 1/133348; G02F 2001/1678

(57) ABSTRACT

The present invention is directed to a pigment particle comprising a core pigment particle the surface of which is covered by a barrier layer formed of a polymer having an average molecular weight of more than about 200 kDa. Such pigment particle used in an electrophoretic fluid can reduce residual image, and thus providing a method for improving performance of an electrophoretic display.

This application is a continuation-in-part of U.S. application Ser. No. 13/338,050, filed Dec. 27, 2011, which is incorporated herein by reference in its entirety.

### FIELD OF THE INVENTION

The present invention is directed to an electrophoretic fluid, especially the pigment particles dispersed in the electrophoretic fluid, which pigment particles have a steric barrier of a high molecular weight.

### BACKGROUND OF THE INVENTION

An electrophoretic display (EPD) is a non-emissive device based on the electrophoresis phenomenon influencing charged pigment particles suspended in a dielectric solvent. An EPD typically comprises a pair of spaced-apart plate-like electrodes. At least one of the electrode plates, typically on the viewing side, is transparent. An electrophoretic fluid composed of a dielectric solvent with charged pigment particles dispersed therein is enclosed between the two electrode plates.

An electrophoretic fluid may have one type of charged pigment particles dispersed in a solvent or solvent mixture of a contrasting color. In this case, when a voltage difference is imposed between the two electrode plates, the pigment particles migrate by attraction to the plate of polarity opposite that of the pigment particles. Thus, the color showing at the transparent plate can be either the color of the solvent or the color of the pigment particles. Reversal of plate polarity will cause the particles to migrate to the opposite plate, thereby reversing the color.

Alternatively, an electrophoretic fluid may have two types of pigment particles of contrasting colors and carrying opposite charges and the two types of pigment particles are dispersed in a clear solvent or solvent mixture. In this case, when a voltage difference is imposed between the two electrode plates, the two types of pigment particles would move to opposite ends. Thus the color of one of the two types of the pigment particles would be seen at the viewing side.

For all types of the electrophoretic displays, the fluid contained within the individual display cells of the display is undoubtedly one of the most crucial parts of the device. The composition of the fluid determines, to a large extent, the residue image, lifetime, contrast ratio, switching rate and bistability of the device.

One of the performance problems with an electrophoretic display is the residue image which could be caused by insufficient particle dispersion stability. For example, when particles are in a state where agglomeration is somewhat favorable, upon switching to an image state (i.e., packing the particles close to the viewing plane of the device), the particles may stick together in a random way. Then when the device is switched again, the particles may behave in an uncontrolled manner, moving in large aggregates, or even sticking to the viewing plane, leading to hysteresis and residual image.

### BRIEF DESCRIPTION OF THE DRAWINGS

FIG. 1 shows GPC trace of a polymer sample from reaction described in the example.

FIG. 2 shows the residual image as a function of the molecular weight of the polymeric layer on core pigment particles.

### SUMMARY OF THE PRESENT INVENTION

A first aspect of the present invention is directed to a pigment particle comprising a core pigment particle the surface of which is covered by a barrier layer formed of a polymer having an average molecular weight of more than about 200 kDa, preferably more than about 235 kDa and more preferably more than about 300 kDa.

In one embodiment, the core pigment particle is an inorganic pigment particle. In another embodiment, the core pigment particle is an organic pigment particle.

In one embodiment, the polymer is polyethylene, polystyrene, polymethylmethacrylate, polybutylmethacrylate, polylaurylmethacrylate, polyvinylpyrrolidone, a polymer of perfluorinated monomer or any combination thereof.

The second aspect of the present invention is directed to an electrophoretic fluid comprising charged pigment particles dispersed in a solvent or solvent mixture wherein said pigment particle comprising a core pigment particle the surface of which is covered by a barrier layer formed of a polymer having an average molecular weight of more than about 200 kDa, preferably more than about 235 kDa and more preferably more than about 300 kDa.

In one embodiment, the fluid has only one type of charged pigment particles.

In one embodiment, the fluid has two types of charged pigment particles and at least one of the two types of the charged pigment particles is the pigment particles the surface of which is bound to a barrier layer formed of a polymer having an average molecular weight of more than about 200 kDa, preferably more than about 235 kDa and more preferably more than about 300 kDa. The two types of charged pigment particles are oppositely charged and of contrasting colors. In one embodiment, they are black and white, respectively.

In one embodiment, the fluid further comprises a charge control agent.

### DETAILED DESCRIPTION OF THE INVENTION

Currently, the molecular weight of the polymer in a barrier layer over the surface of the core pigment particles used in an electrophoretic display is in the range of about 30 to about 200 kDa. In most cases, it is less than about 175 kDa.

It has now been found by the present inventor that the residual image of an electrophoretic display may reduce exponentially when the molecular weight of the polymer attached to the core pigment particles increases.

Therefore, the first aspect of the present invention is directed to core pigment particles coated with a polymer layer and said polymer layer is formed of polymer molecules having an average molecular weight of more than about 200 kDa, preferably more than about 235 kDa and more preferably more than about 300 kDa.

The core pigment particles over which the polymer layer is formed may be inorganic or organic pigment particles. Inorganic pigment particles may include, but are not limited to, TiO₂, ZrO₂, ZnO, Al₂O₃, CI pigment black 26 or 28 or the like (e.g., manganese ferrite black spinel or copper chromite black spinel). Organic pigment particles may include, but are not limited to, phthalocyanine blue, phthalocyanine green, diarylide yellow, diarylide AAOT yellow, and quinacridone, azo, rhodamine, perylene pigment series from Sun Chemical, Hansa yellow G particles from Kanto Chemical, and Carbon Lampblack from Fisher.

The polymer of a high molecular weight forming a steric barrier layer over the surface of the core pigment particles, according to the present invention, may be of any type or chemical composition. However, it is preferred that the polymer is compatible with the electrophoretic fluid in which the pigment particles are dispersed.

Suitable polymers may include, but are not limited to, polyethylene, polystyrene, polymethylmethacrylate, polybutylmethacrylate, polylaurylmethacrylate, polyvinylpyrrolidone, polymers of perfluorinated monomer, and any combination thereof including their possible co-polymers.

In an electrophoretic fluid comprising an aliphatic solvent, appropriate polymers may be easily grafted to pigment surface through free radical polymerization of acrylic type monomers. Other polymeric steric barriers may also be created by polymerization technique, such as condensation, atom transfer radical polymerization (ATRP), reversible addition-fragmentation chain transfer (RAFT) or the like.

For free radical polymerization of acrylic type monomers, it is found that those acrylic monomers having a longer side carbon chain (of, for example, C₆-C₁₈) are particularly useful. For example, acrylic monomers having a side chain of 12 carbon atoms, i.e., lauryl methacrylate, are well suited to create high molecular weight polymers. The resulting polymer, poly-(lauryl methacrylate) is capable of imparting dispensability and dispersion stability to the pigment particles in an organic solvent in an electrophoretic fluid.

To attach a high molecular weight polymer to the surface of pigment particles, polymerizable groups are first introduced onto the surface of the core pigment particles. The resulting particles are then dispersed into a solvent, followed by adding monomers and an initiator to grow the polymer from the surface of the pigment particles. By this method, there are several critical parameters that must be controlled to achieve the desired result of a high molecular weight polymeric barrier layer over the core pigment particles.

For example, the concentrations of the monomer and the initiator must be controlled precisely in order to achieve the desired end product. In particular, a very low initiator concentration (e.g., about 0.01% to about 0.08% by weight) must be used and in addition, a higher monomer concentration (e.g., about 20% to about 35% by weight) would also contribute to an increased molecular weight of the polymer formed.

The above description refers to free radical polymerization, it is, however, also applicable to other types of polymerization technique.

The second aspect of the present invention is directed to an electrophoretic fluid comprising the pigment particles of the present invention, which are dispersed in a solvent.

The solvent in which the pigment particles are dispersed preferably has a low viscosity and a dielectric constant in the range of about 2 to about 30, preferably about 2 to about 15 for high particle mobility. Examples of such a solvent may include hydrocarbons such as Isopar, decahydronaphthalene (DECALIN), 5-ethylidene-2-norbornene, fatty oils, paraffin oil; silicon fluids; aromatic hydrocarbons such as toluene, xylene, phenylxylylethane, dodecylbenzene and alkylnaphthalene; halogenated solvents such as perfluorodecalin, perfluorotoluene, perfluoroxylene, dichlorobenzotrifluoride, 3,4,5 -trichlorobenzotrifluoride, chloropentafluoro-benzene, dichlorononane, pentachlorobenzene; and perfluorinated solvents such as FC-43, FC-70 and FC-5060 from 3M Company, St. Paul MN, low molecular weight halogen containing polymers such as poly(perfluoropropylene oxide) from TCI America, Portland, Oreg., poly(chlorotrifluoro-ethylene) such as Halocarbon Oils from Halocarbon Product Corp., River Edge, N.J., perfluoropolyalkylether such as Galden from Ausimont or Krytox Oils and Greases K-Fluid Series from DuPont, Del., polydimethylsiloxane based silicone oil from Dow-corning (DC -200). The solvent or solvent mixture may be colored by a dye or pigment.

A preferred solvent has a low dielectric constant (preferably about 2 to 3), a high volume resistivity (preferably about 1015 ohm-cm or higher) and a low water solubility (preferably less than 10 parts per million). Suitable hydrocarbon solvents may include, but are not limited to, dodecane, tetradecane, the aliphatic hydrocarbons in the Isopar® series (Exxon, Houston, Tex) and the like. The solvent can also be a mixture of a hydrocarbon and a halogenated carbon or silicone oil base material.

The present invention is applicable to a one-particle, two-particle or multiple-particle electrophoretic fluid system.

In other words, the present invention may be directed to an electrophoretic fluid comprising only the pigment particles prepared according to the present invention which are dispersed in a solvent, such as a hydrocarbon solvent. The pigment particles and the solvent have contrasting colors.

Alternatively, the present invention may be directed to an electrophoretic fluid comprising two types of pigment particles dispersed in a solvent and at least one of the two types of the pigment particles is prepared according to the present invention. The two types of pigment particles carry opposite charge polarities and have contrasting colors. For example, the two types of pigment particles may be black and white respectively. In this case, the black particles may be prepared according to the present invention, or the white particles may be prepared according to the present invention, or both black and white particles may be prepared according to the present invention.

In a two particle system, if only one type of the pigment particles is prepared according to the present invention, the other type of pigment particles may be prepared by any other methods. For example, the particles may be polymer encapsulated pigment particles. Microencapsulation of the pigment particles may be accomplished chemically or physically. Typical microencapsulation processes include interfacial polymerization/crosslinking, in-situ polymerization/crosslinking, phase separation, simple or complex coacervation, electrostatic coating, spray drying, fluidized bed coating, solvent evaporation or the like.

In a multiple particle system, at least one type of pigment particles is prepared according to the present invention and the other types of particles may be prepared by other methods as described above.

The pigment particles in the electrophoretic fluid may exhibit a natural charge, or may be charged explicitly using a charge control agent, or may acquire a charge when suspended in a solvent or solvent mixture. Suitable charge control agents are well known in the art; they may be polymeric or non-polymeric in nature, and may also be ionic or non-ionic, including ionic surfactants such as dye materials, sodium dodecylbenzenesulfonate, metal soap, polybutene succinimide, maleic anhydride copolymers, vinylpyridine copolymers, vinylpyrrolidone copolymer, (meth)acrylic acid copolymers, N,N-dimethylaminoethyl (meth)acrylate copolymers or the like.

The electrophoretic dispersion of the present invention may also comprise other additives, such as those commonly used in an electrophoretic fluid.

The following is a written procedure to illustrate how a high molecular weight polymeric layer may be formed over the surface of core pigment particles. However, it should be noted that this example is for illustration purpose only and therefore, the procedure may be modified and the reaction conditions, such as temperatures and times, may also be adjusted depending on the desired final product.

### EXAMPLE

Core pigment particles, DuPont R902 (SiO₂/Al₂O₃ coated TiO₂) is used in this example. At first, 1000 g of R902 is dispersed into 4000 g of 2-butanone (i.e., methyl ethyl ketone, MEK) in a covered 10 L high density polyethylene bottle. The container is immersed into a 65° C. sonicated water bath. The dispersion is stirred vigorously by an overhead stirring motor with a pitched 4-blade stirrer attached.

Once the mixture reaches at least 63° C., 320 g of Xiameter® OFS-6030 is added over 5 minutes. Xiameter® OFS-6030 (γ-methacryloxypropyltrimethoxysilane) is primarily comprised of a bi-functional molecule where one end of the molecule can be bound to the particle surface through a typical silanization reaction and the other end of the molecule is an acrylate which is polymerizable, i.e., it is reactive and contains a carbon-carbon double-bond.

After 3 hours, the mixture is then removed from the 65° C. sonic water bath. The mixture is cooled at room temperature while being continuously stirred for at least another hour. The dispersion is poured into 6 1 L polypropylene bottles. These bottles are then placed into a Sorval RC-6 centrifuge and spun at 4800RPM for about 20 minutes. The resulting two-phase material is then separated by decanting the liquid to waste. The centrifuged cake is air dried for 1 hour before being placed in a 70° C. vacuum oven for 18 hours.

The pigment particles with bound polymerizable groups are re-dispersed into a polymerization solvent (i.e., toluene). Specifically, 1000 g of treated pigment particles are added to 2000 g of toluene in a covered 4 L high density polyethylene bottle. The container is immersed into a 65° C. sonicated water bath. The dispersion is stirred vigorously by an overhead stirring motor with a pitched 4-blade stirrer attached. After 2 hours, the mixture is added to a 4 L glass jacketed reactor with a lid. Next, 1500 g of lauryl methacrylate is added to the reactor, followed by sealing the reactor and stirring the content of the reactor by an overhead stirrer with a teflon stirring paddle. Nitrogen is bubbled through the reaction mixture. Heated water is pumped through the jacket of the reactor to maintain a constant reactor temperature of 70° C. An initiator in the amount of 2.8 g, 2,2 azobisisobutyronitrile (AIBN), is dissolved into 285 g of toluene. Once the reaction mixture temperature has stabilized and has been satisfactorily purged of oxygen (i.e., at least 1 hour), the initiator solution is added to the reactor drop-wise over the course of 1 hour. After 19 hours, the reaction mixture is cooled by pumping room temperature water through the reactor jacket. The mixture is drained into 4 1 L polypropylene bottles. These bottles are then placed into a Sorval RC-6 centrifuge and spun at 4800 RPM for 60 minutes. The resulting two-phase material is then separated.

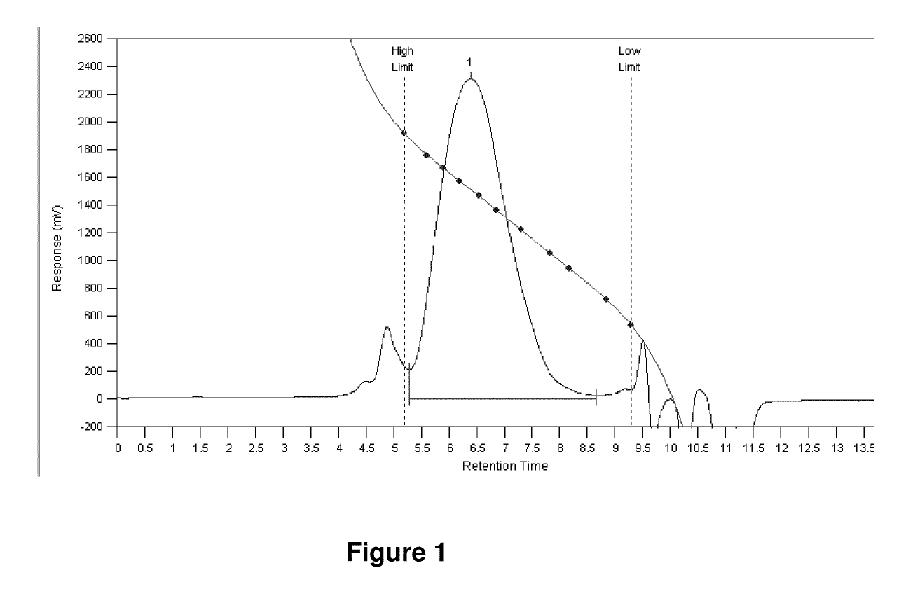

A sample of the liquid phase is retained for determination of the molecular weight of the coated polymers. The liquid sample is dried and then dissolved in tetrahydrofuran (THF). The polymer solution is then passed through a gel permeation chromatograph, GPC, for determination of the molecular weight. An example of a typical GPC trace is provided in FIG. 1. GPC standard polymethyl-methacrylate is used to generate the calibration curve. Based on the retention time and standard molecular weight, the GPC instrument program indicates molecular weight value of the sample. The molecular weight of the polymer, in this case, is about 240 kDa.

While remaining in the bottles, the centrifuged cake is then re-dispersed into ethyl acetate. These bottles are then placed into a Sorval RC-6 centrifuge and spun at 4800 RPM for 30 minutes. The resulting two-phase material is then separated by decanting the liquid to waste. This ethyl acetate wash is repeated again. Finally the wet cake is air dried for 1 to 4 hours then dried in a 70° C. vacuum oven overnight. The resulting cake can be dispersed into an electrophoretic fluid to act as negatively charged white particles where the high molecular weight polymer layer over the white particles will cause a display device to have low or no residual image.

The dried pigment particles have covalently bound polymerizable groups on the surface. The efficacy of the reaction is judged by the organic content of the pigment particles as measured by their weight loss at an elevated temperature by thermal gravimetric analyzer, TGA. Typically, the pigment particles resulted from this procedure will contain 3 to 15 weight % of an organic matter.

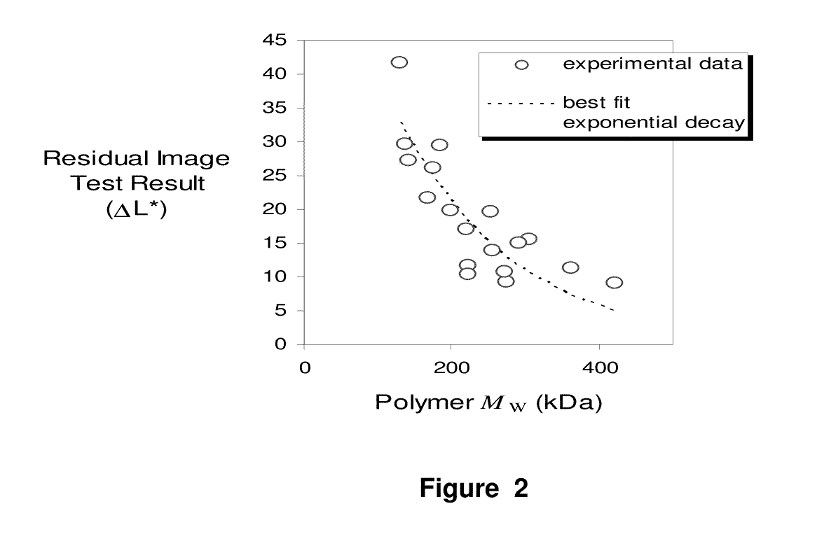

FIG. 2 shows the correlation between residue image and polymer molecular weight on the pigment particle surface. In color science, L, is used to define an optical state. The lightness, L*, represents the darkest black at L*=0, and the brightest white at L*=100. A lower ΔL* value indicates better image stability or better bistability. FIG. 2 demonstrates that the residual image of an electrophoretic display reduces exponentially when the molecular weight of the polymer attached to the core pigment particles increases. In other words, a higher molecular weight of the polymer on the particle surface results in better image stability.

While the present invention has been described with reference to the specific embodiments thereof, it should be understood by those skilled in the art that various changes may be made and equivalents may be substituted without departing from the and scope of the invention. In addition, many modifications may be made to adapt a particular situation, materials, compositions, processes, process step or steps, to the objective, spirit and scope of the present invention. All such modifications are intended to be within the scope of the claims appended hereto.

What is claimed is:

1. A method for improving performance of an electrophoretic display, comprising:
(a) obtaining charged pigment particles each comprising a core pigment particle covered by a barrier layer formed of a polymer having an average molecular weight of more than 200 kDa,
(b) dispersing the pigment particles of (a) in a solvent or solvent mixture to form an electrophoretic display fluid,
(c) enclosing the electrophoretic fluid between two electrode plates to form an electrophoretic display, and
(d) switching the electrophoretic display from one image state to another image state,
whereby a residual image of the electrophoretic display is reduced.

2. The method of claim 1, wherein the average molecular weight of the polymer is more than about 235 kDa.

3. The method of claim 2, wherein the average molecular weight of the polymer is more than about 300 kDa.

4. The method of claim 1, wherein the core pigment particle is an inorganic pigment particle.

5. The method of claim 1, wherein the core pigment particle is an organic pigment particle.

6. The method of claim 1, wherein the polymer is polyethylene, polystyrene, polymethylmethacrylate, polybutylmethacrylate, polylaurylmethacrylate, polyvinylpyrrolidone, a polymer of perfluorinated monomer, or any combination thereof.

7. The method of claim 1, wherein the electrophoretic display fluid contains only one type of charged pigment particles.

8. The method of claim 1, wherein the electrophoretic display fluid contains two types of charged pigment particles, and at least one of the two types is the charged pigment particles of step (a).

9. The method of claim 8, wherein the two types of charged pigment particles are oppositely charged and of contrasting colors.

10. The method of claim 9, wherein the two types of charged pigment particles are black and white, respectively.

11. The method of claim 1, wherein the electrophoretic display fluid further comprises a charge control agent.
